(19) United States
(12) Patent Application Publication
(10) Pub. No.: US 2008/0014368 A1
(43) Pub. Date: Jan. 17, 2008

(54) Method for refinishing vehicles

(76) Inventors: Wolfgang Feyrer, Koln (LI); Andrew Duda, Gladbeck (DD); Stephen Naylor, Lancashire (GB); Harald Kloeckner, Lindlar (DD)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/789,834

(22) Filed: Apr. 25, 2007

Related U.S. Application Data
(60) Provisional application No. 60/799,519, filed on May 11, 2006.

(51) Int. Cl. C08J 7/18

(52) U.S. Cl. 427/514; 34/270

(57) ABSTRACT

The invention is directed to a method for refinishing vehicles using infrared technology for drying and curing the paint coating. The method comprises the steps: A) applying a layer of a pigmented coating composition over a vehicle body or vehicle body part, subsequently applying a layer of clear coating composition, or applying alternatively a layer of pigmented top coating composition over the vehicle body or vehicle body part and B) curing the coating layers applied in step A), directly after completion of the application step, without interposing a final evaporation phase, by exposing to infrared radiation using a short-wave infrared radiator, a radiator distance in the range of 20 to 60 cm being adjusted and the quotient of radiator power in Kilowatt and radiator distance in centimeter ranges from 0.07 to 0.15.

### CROSS-REFERENCE TO RELATED APPLICATION

This application claims the benefit of U.S. Provisional Application Ser. No. 60/799,519 filed on May 11, 2006 which is hereby incorporated by reference in its entirety.

### FIELD OF THE INVENTION

The invention relates to a method for refinishing vehicles using infrared technology for drying and curing the paint coating.

### DESCRIPTION OF RELATED ART

The infrared drying method is a preferred means in the field of vehicle refinishing and is used in particular for drying or curing undercoat materials, such as primer or filler layers outside the paint spraying booth, for example in so-called filler stations. In this case, infrared technology is used particularly for spot-repair and refinishing vehicle body parts, for example vehicle doors, engine bonnets and wings. Short-wave and medium-wave infrared radiators have become increasingly successful in practice. The increased use of medium-wave and short-wave infrared radiators in car refinishing is due to the following reasons: high heat transfer power with a short heating-up time, low energy consumption (heat is produced only where it is needed), no thermal energy losses through the transfer medium of air, shortened process duration and thus higher throughput.

However, care should be taken when using the infrared drying method not to exceed paint film temperatures (object temperature of the coated substrate) which are to be observed. This means that radiation times, radiator power and distance between the radiator and the substrate are to be selected according to application-oriented guidelines. In particular the curing of two-pack top and clear coating compositions may be problematic if a temperature control device is not used, because this may readily lead to areas of the paint surface overheating and thus to defects in the paint surface, such as pinholes, blister formation and reduction of gloss of the paint film.

In order to avoid the formation of pinholes and other surface defects, the infrared radiator must be positioned at a specific minimum distance to the object which must be increased the shorter the radiation wave used. When short-wave infrared radiators are used, a safe radiator distance is, for example, from 70 to 100 cm. On account of the risk of pinhole formation during the first drying phase, drying with short-wave infrared radiators may also, in certain cases, initially be carried out at half the capacity (50%) of the radiator, said radiator then being switched to full capacity (100%). If the above-mentioned measures are not met, overheating may then result, in particular during radiation with short-wave infrared radiators, and thus pinholes may form on the paint surface. Although the aforementioned measures contribute towards achieving a perfect surface quality, they reduce the effectiveness of the refinishing, i.e. the entire painting process takes longer.

Thus, there is a need for methods for refinishing vehicle bodies using infrared technology, with which paint coatings which have a perfect visual surface quality are obtained efficiently, i.e. within short curing times, wherein the paint coatings are also to meet the other qualitative requirements imposed on refinishing also stipulated in the automobile industry specifications, for example with respect to hardness, chemical resistance and overall appearance.

### SUMMARY OF THE INVENTION

The invention relates to a method for refinishing vehicles, comprising the following steps:
A) applying a layer of a pigmented coating composition over an area of a pre-coated surface of a vehicle body or vehicle body part, subsequently applying a layer of a clear coating composition over said layer of a pigmented coating composition, and
B) curing said layers applied in step A) by exposing said layers to infrared radiation directly after completion of said step A), i.e. without using an evaporation phase, wherein a short-wave infrared radiator is used, a radiator distance is being adjusted in the range from 20 to 60 centimeters and wherein the quotient of radiator power in Kilowatt of said short-wave infrared radiator to the radiator distance in centimeters ranges from 0.07 to 0.15.

Alternatively the invention relates to a method for refinishing vehicles, comprising the steps:
A) applying a layer of a pigmented top coating composition over an area of a pre-coated surface of a vehicle body or vehicle body part, and
B) curing said coating layer applied in step A) by exposing said layer to infrared radiation directly after completion of said step A), i.e. without using an evaporation phase, wherein a short-wave infrared radiator is used, a radiator distance being adjusted in the range from 20 to 60 centimeters and wherein the quotient of radiator power in Kilowatt of said short-wave infrared radiator to the radiator distance in centimeters ranges from 0.07 to 0.15.

Surprisingly, it has been found that the method according to the invention allows high-quality paint coatings to be obtained which are free from pinholes, using a greatly reduced total drying time (=radiation time+set-up time) of approximately 3 to 6 minutes, preferably 4 to 5 minutes and a greatly reduced radiation time of approximately 2 to 4 minutes, preferably 2 to 3 minutes. These paint coatings have an outstanding visual appearance and exhibit the other technological characteristics required for refinishing, for example a specific hardness, chemical resistance and overall appearance, such as in particular flow and gloss. It was completely surprising and could not be deduced from the prior art that, in spite of shortening the distance between infrared radiator and substrate surface to be irradiated, while observing the aforementioned quotient, high-quality, pinhole-free, high-gloss coats could be achieved even when the method was carried out immediately using the full radiator capacity (100%). It is conventional practice when using short-wave infrared radiators to observe a minimum distance between infrared radiator and substrate surface of at least 70 to 100 cm (depending e.g. on the power of the radiator) and/or the method is carried out with two drying phases of a different capacity, as already described above. In this case however, drying times of approximately 10 to 16 minutes are required. It was also surprising that an improved feel (very high smoothness) of the coating was achieved by the method according to the invention.

The present invention may advantageously be used for drying or curing solvent-based and water-based topcoat layers, i.e. for drying or curing solvent-based or water-based single-layer pigmented topcoats or solvent-based or water-based clear coating compositions applied over solvent-based or water-based pigmented coating compositions.

### DETAILED DESCRIPTION OF THE EMBODIMENTS

These and other features and advantages of the present invention will be more readily understood, by those of ordinary skill in the art, from a reading of the following detailed description. It is to be appreciated those certain feature of the invention, which are, for clarity, described above and below in the context of separate embodiments, may also be provided in combination in a single embodiment. Conversely, various feature of the invention that are, for brevity, described in the context of a single embodiment, may also be provided separately or in any sub-combination. The use of numerical values in the various ranges specified in this application, unless expressly indicated otherwise, are stated as approximations as though the minimum and maximum values within the stated ranges were both preceded by the word “about”. In this manner slight variations above and below the stated ranges can be used to achieve substantially the same results as value within the ranges. Also, the disclosure of these ranges is intended as continuous range including every value between the minimum and maximum values, including the minimum and maximum end points of the range.

The present invention will be described in more detail in the following.

The term “infrared” will henceforth be abbreviated to IR.

Radiator power is defined here as the power of the IR radiator having a single cassette head. The power is usually given in the unit Watt (W) or Kilowatt (kW).

Radiator distance is defined here as the distance between the radiator field of the IR radiator and the surface of the vehicle body or vehicle body part to be irradiated.

The parameter Q is the quotient of the radiator power of the short-wave IR radiator, in Kilowatt (kW), to the radiator distance, in centimeter (cm) (Q=radiator power (kW): radiator distance (cm))

The term “curing” is understood as meaning chemical crosslinking and/or physical drying.

A short-wave IR radiator is understood as meaning an IR radiator which emits radiation in the range of short-wave IR radiation. The International Electrotechnical Commission (IEC) divides the spectrum of IR radiation into three ranges: short-wave IR, medium-wave IR and long-wave IR. In the case of short-wave IR which is used in the present invention, this is IR radiation of the wave length range of about 0.8 to 2 μm. The radiation emitted by a short-wave IR radiator has, for example, an emission maximum at wavelengths of between 1.2 and 1.7 μm.

“Evaporation phase” denotes in refinishing the temporal phase which is usually interposed after the application of coating compositions to allow the solvents and/or water in the coating composition to evaporate at least partly in a certain amount. Such evaporation phases are interposed after the application of coating compositions has been completed and before applying a further layer of coating composition and/or before curing the applied coating layer.

The temporal phase which is usually interposed after the application of coating compositions has been completed to allow the solvents and/or water to evaporate in a certain amount and before curing the applied coating layer is also called “final evaporation phase”. After final evaporation the coating layer is then cured by different means, e.g. by supplying heat.

Usual evaporation times, in particular usual final evaporation times range e.g. from 5 to 10 minutes for solvent based coating compositions and e.g. from 10 to 15 minutes for water based coating compositions.

The term (meth)acrylic as used herein should be taken to mean methacrylic and/or acrylic.

Number average molecular weight and weight average molecular weight referred to herein are determined by GPC (gel permeation chromatography) using polystyrene as the standard and tetrahydrofuran as the liquid phase.

In the method according to the invention, the preparation of the damaged area or of the vehicle body or vehicle body part to be painted may be carried out as the first step, if necessary, in a conventional manner. The preparation may be carried out, for example, by cleaning, sanding, cleaning again and applying a stopper, primer and/or filler. These materials may be conventional coating compounds, as used by a person skilled in the art of vehicle repair painting as stoppers, fillers and/or primers. The materials which are used may be based on solvents or water and may be cured in conventional manner. However, the materials may also be applied to an old cured paint coating or to a factory paint coating which is still intact.

According to step A) of the method according to the invention a topcoat layer of a pigmented single-layer top coating composition or a topcoat layer of a pigmented coating composition and a transparent clear coating composition is applied to the pre-coating thus obtained or to a paint coating which is already present.

The method according to the invention will now be considered in more detail with respect to the application of a layer of a pigmented coating composition and a subsequently applied layer of a transparent clear coating composition over said layer of a pigmented coating composition. The pigmented coating composition is usually called a color and/or effect imparting base coat composition.

Thus, the color and/or effect imparting base coat composition is initially applied to the pre-coating. The base coat composition may be a conventional solvent-based or water-based paint which imparts color and/or effect to the final coating. Binder systems which may be used in the color- and/or effect-imparting base coat compositions include, for example, those based on water-dilutable or solvent-dilutable polyurethane, acrylated polyurethane, polyacrylate, polyester, acrylated polyester and/or alkyd resins. The binder systems may be physically drying and/or may be chemically crosslinking by polymerisation, polycondensation and/or polyaddition reactions. They may also contain other resins, for example cellulose esters. The aforementioned list of binder systems is merely an example. The binders may also be modified more comprehensively and combined together in any manner. The binders which may be used are not subject to any particular restrictions. Any binders may be used which are known to a person skilled in the art and are conventional in the formulation of color- and/or effect-imparting base coat compositions, particularly in the field of vehicle refinishing.

The color- and/or effect-imparting base coat compositions contain color- and/or effect-imparting pigments. The layer of the color- and/or effect-imparting base coat composition containing those pigments imparts the final coating a desired color and/or effect, e.g. a metallic effect or a flop effect. Any organic or inorganic pigments conventional in paint are suitable as color-imparting pigments. Examples of organic or inorganic color-imparting pigments include titanium dioxide, micronised titanium dioxide, ion oxide pigments, carbon black, azo pigments, phthalocyanine pigments, quinacridone or pyrrolopyrrol pigments. Examples of effect-imparting pigments include metal pigments, for example from aluminium, copper or other metals; interference pigments, for example metal oxide-coated metal pigments, for example aluminium coated with titanium dioxide or mixed oxide, coated mica, for example mica coated with titanium dioxide and graphite effect pigments. The base coat compositions may also contain organic solvents and/or water, and optionally additives conventional in paint.

Once the base coat composition has been applied, the clear coating composition is then applied thereto. This is either carried out after the base coat composition layer has cured or wet-in-wet, optionally after an interposed evaporation phase, e.g. after an evaporation phase of about 5-10 minutes at room temperature in case of solventborne base coat compositions and of about 20-30 minutes at room temperature in case of waterborne base coat compositions The clear coating composition is preferably applied wet-in-wet to the base coat composition layer after an evaporation phase. The clear coating compositions are applied in a resulting dry film thickness of approximately 40 to 60 μm, by conventional application methods, preferably by spray application, for example using a conventional spray gun.

In principle, all known transparent or non-transparent pigmented coating compounds may be used as clear coating compositions, as are conventional in vehicle refinishing. The clear coating composition may be solvent- or water-based.

Water-based coating compositions are coating compositions, wherein water is used as solvent or thinner when preparing and/or applying the coating composition. Usually water-based coating compositions contain 20 to 80% by weight of water, based on the total amount of the coating composition and optionally up to 15% by weight, preferably below 10% by weight of organic solvents, based on the total amount of the coating composition. Solvent-based coating compositions are coating compositions, wherein organic solvents are used as solvent or thinner when preparing and/or applying the coating composition. Usually solvent-based coating compositions contain 20 to 80% by weight of organic solvents, based on the total amount of the coating composition.

The clear coating compositions contain conventional binders, for example binders based on polyurethane, (meth)acrylated polyurethane, poly(meth)acrylate, polyester and (meth)acrylated polyester resins and hybrid binders based on polyesters/poly(meth)acrylates or on polyurethanes/poly(meth)acrylates. The binders are preferably chemically crosslinkable by a polymerisation, polycondensation and/or polyaddition reaction. Thus they contain correspondingly crosslinkable functional groups. Suitable functional groups include, for example, hydroxyl groups, isocyanate groups, acetoacetyl groups, unsaturated groups, for example (meth)acryloyl groups, epoxide groups and amino groups. For crosslinking, the binders contain crosslinkers with corresponding complementary reactive functional groups, for example polyisocyanates or polyamines. The clear coating compositions may optionally also contain physically drying binders. The aforementioned list of binders and crosslinkers is merely an example. Said binders and crosslinkers may also be modified more comprehensively and combined together in any manner. Any binders which are known to a person skilled in the art and are conventional in the formulation of transparent clear coating compositions, particularly in the field of vehicle refinishing, may be used.

Where water-based clear coating compositions are concerned, the binders must be used in water-dilutable form. This may be carried out in a manner known to a person skilled in the art by ionic and/or non-ionic modification of the binders. An anionic and/or non-ionic modification is preferred. Anionic modification may be achieved, for example, by the incorporation of carboxyl groups and the at least partial neutralisation thereof. Non-ionic modification may be achieved, for example, by incorporating polyethylene oxide units.

The clear coating compositions are preferably two-component clear coating compositions, in particular based on hydroxy functional binder components and polyisocyanate crosslinkers, wherein the crosslinking occurs between the hydroxyl groups of the binder and the isocyanate groups of the crosslinker. But the clear coats can also contain binders with blocked hydroxyl groups, which can be deblocked under the influence of humidity/water.

The hydroxy-functional binders are oligomeric and/or polymeric compounds with a number average molecular weight (Mn) of, e.g., 500 to 500,000 g/mole, preferably of 1100 to 300,000 g/mole.

The binders with hydroxyl groups are for example the polyurethanes, (meth)acrylic copolymers, polyesters and polyethers, known from polyurethane chemistry to the skilled person, which are used in the formulation of aqueous and solvent-borne coating compositions. They may each be used individually or in combination with one another.

Examples of hydroxy-functional polyurethane resins are those, for example, with a number average molecular weight Mn of 500 to 500 000 g/mol, preferably, of 1100 to 300 000 g/mol, most preferably, of 5000 to 300 000 g/mol, an acid value of 0 to 100 mg KOH/g, preferably of 0 to 80 mg KOH/g, and a hydroxyl value of 40 to 400 mg KOH/g, preferably, of 80 to 250 mg KOH/g.

The polyurethane resins include such resins which are in modified form, for example, as silicon-modified or (meth)acrylated polyurethane resins.

Examples of poly(meth)acrylate resins are for example those with a number average molecular mass Mn of 1000-20000 g/mol, preferably, of 1100-15000, an acid value of 0-100 mg KOH/g, preferably, of 0-50 and a hydroxyl value of 40-400 mg KOH/g, preferably, of 60-200 mg KOH/g. The poly(meth)acrylate resins can also have been prepared in the presence of different binders, e.g., in the presence of oligomeric or polymeric polyester and/or polyurethane resins.

Examples of hydroxy-functional polyester resins are for example hydroxyfunctional polyesters with a number average molecular weight of 500-10,000 g/mol, preferably, of 1100-8000 g/mol, an acid value of 0-150 mg KOH/g, preferably, of 0-50 mg KOH/g and a hydroxyl value of 40-400 mg KOH/g, preferably, of 50-200 g/mol.

The coating compositions can also contain low molecular reactive components, so-called reactive thinners, which are able to react with the cross-linking components.

The preferred clear coats contain polyisocyanates with free isocyanate groups as cross-linking agents. Examples of polyisocyanates are any number of organic polyisocyanates with aliphatically, cycloaliphatically, araliphatically and/or aromatically bound free isocyanate groups. The polyisocyanates are liquid at room temperature or become liquid through the addition of organic solvents. At 23° C., the polyisocyanates generally have a viscosity of 1 to 6,000 mPas, preferably, above 5 and below 3,000 mPas.

The preferred polyisocyanates are polyisocyanates or polyisocyanate mixtures with exclusively aliphatically and/or cycloaliphatically bound isocyanate groups with an average NCO functionality of 1.5 to 5, preferably 2 to 4.

Examples of particularly suitable polyisocyanates are what are known as “paint polyisocyanates” based on hexamethylene diisocyanate (HDI), 1-isocyanato-3,3,5-trimethyl-5-isocyanatomethyl-cyclohexane (IPDI) and/or bis(isocyanatocyclohexyl)-methane and the derivatives known per se, containing biuret, allophanate, urethane and/or isocyanurate groups of these diisocyanates which, following production, are freed from surplus parent diisocyanate, preferably by distillation, with only a residue content of less than 0.5% by weight. Triisocyanates, such as, triisocyanatononan can also be used.

Sterically hindered polyisocyanates are also suitable. Examples of these are 1,1,6,6-tetramethyl-hexamethylene diisocyanate, 1,5-dibutyl-penta-methyldiisocyanate, p- or m-tetramethylxylylene diisocyanate and the appropriate hydrated homologues.

In principle, diisocyanates can be converted by the usual method to higher functional compounds, for example, by trimerization or by reaction with water or polyols, such as, for example, trimethylolpropane or glycerine. The polyisocyanates can also be used in the form of isocyanate-modified resins.

The polyisocyanate cross-linking agents can be used individually or mixed.

The polyisocyanate cross-linking agents are those commonly used in the paint industry, and are described in detail in the literature and are also obtainable commercially.

The clear coating compositions also contain organic solvents and/or water. The organic solvents are conventional paint solvents. These may originate from the production of the binders or are added separately. Examples of suitable solvents include mono- or polyvalent alcohols, for example propanol, butanol, hexanol; glycol ethers or glycol esters, for example diethylene glycol dialkyl ether, dipropylene glycol dialkyl ether, each with C1 to C6 alkyl, ethoxy propanol, butyl glycol; glycols, for example ethylene glycol, propylene glycol, N-methylpyrrolidone and ketones, for example methyl ethyl ketone, acetone, cyclohexanon; aromatic or aliphatic hydrocarbons, for example toluene, xylene or linear or branched aliphatic C6-C12 hydrocarbons.

The clear coating compositions may also contain additives conventional in paints. These additives are the conventional additives which may be used in the paint domain. Examples of additives of this type include light stabilisers, for example based on benztriazoles and HALS compounds, flow agents based on (meth)acryl-homopolymers or silicone oils, rheology-influencing agents, such as highly dispersed silica or polymeric urea compounds, thickeners, such as cross linked-on polycarboxylic acid or polyurethanes, anti-foaming agents, wetting agents, curing accelerators, for example for the crosslinking reaction of OH-functional binders with the polyisocyanate crosslinkers, for example organic metallic salts, such as dibutyl tin dilaurate, zinc naphthenate and compounds containing tertiary amino groups, such as triethylamine. The additives are used in commonly used quantities conventional to a person skilled in the art.

The clear coating compositions may contain different amounts of solids. Preferred solvent-based clear coating compositions may have, for example, solids contents which correspond to a VOC value of <420 g/l (VOC=volatile organic compounds).

The clear coating compositions may be applied in one or two spraying passes. After the application thereof, the clear coating composition layer applied in step A) is irradiated with IR radiation according to step B) of the method according to the invention, that is directly after completion of the application step A), without the interposition of a (final) evaporation phase.

Irradiation may be carried out within 10 to 120 seconds, preferably within 20 to 90 seconds and most preferred within 20 to 60 seconds after the application procedure of step A) has been completed. This short time between the completion of the application in step A) and the beginning of the curing is the so-called set-up time, which is needed merely to e.g. prepare and position the IR radiator accordingly. This set-up time is therefore much shorter than the final evaporation phase usually used in the coating process of the prior art to ensure film surfaces without surface defects such as pinholes.

Irradiation is carried out using a short-wave IR radiator, a radiator distance being in the range from 20 to 60 cm, preferably from 20 to 50 cm, and the parameter Q having to correspond to the aforementioned defined values, as a function of the radiator power. When IR radiation is used for curing the clear coating composition according to prior art processes, a final evaporation phase, for example from 5 to 10 minutes, is usually interposed after applying of the clear coating composition and before the irradiation. This final evaporation phase is not used according to the invention.

Alternatively, pigmented single-layer topcoats may also be applied according to the invention as the topcoat layer. In so doing, the procedure is in principle as described above, the pigmented single-layer topcoat being directly applied to the precoating, prepared in the course of refinishing, or to a coating which is already present. The pigmented single-layer topcoats may also be solvent- or water-based. With respect to the composition thereof, i.e. with respect to the constituents thereof, such as binders, crosslinkers, paint-conventional additives and organic solvents and water, the same constituents as in the clear coating compositions described above may basically be used. However, the pigmented single-layer topcoats also contain color- and/or effect-imparting pigments, for example those already mentioned above in the description of the color- and/or effect-imparting base coat compositions. The layer of the pigmented top coating composition containing those pigments imparts the final coating a desired color and/or effect, e.g. a metallic effect or a flop effect.

The single-layer pigmented top coating compositions are preferably also two-component coating compositions, in particular based on hydroxyfunctional binder components and polyisocyanate crosslinkers. The information given concerning the corresponding two-component clear coating compositions also applies to the hydroxyfunctional binders and polyisocyanate crosslinkers to be used.

Preferably the method of the present invention can be used with good results when applying the clear coating composition to a layer of light pigmented base coat composition, e.g. a silver-metallic base coat composition and a white base coat composition, and accordingly when applying the single-layer topcoat to a light pigmented undercoat.

Short-wave IR radiators are used according to the invention to cure the topcoats. Short-wave IR radiators are known and may be obtained from various commercial suppliers. The radiation sources are, for example, silicate glass tubes as round tube radiators or twin tube radiators. Short-wave IR radiators have, for example, a radiator temperature of approximately 1,600° C. to approximately 2,000° C. and a radiation power of 2 to 7 kW, preferably of 3 to 6 kW, whereas radiation power refers to a single cassette head. They may have a power density of approximately 70 to 90 kW/m². Short-wave IR radiators may be obtained, for example, from the following manufacturers: Heraeus Nobel, Hedson Technologies, Herkules-Hebetechnik GmbH and Edwin Trisk Limited/UK. Examples of IR radiators which may be used include IRT-401 XLNC, IRT-402 XLNC, Multicure 140 and Spektraltherm-400 S.

Various types of device may be used as the IR radiators, depending on the size and shape of the parts to be painted. If small and medium-sized surfaces are to be dried, for example a relatively small damaged area within a surface or small to medium-sized vehicle parts, for example bonnets, so-called stand radiators with one or two cassette modules are used. Where there are larger areas to be dried, for example a vehicle roof, large-area radiators with four cassettes are used which may be flexibly integrated into a painting booth via wall or roof track elements. Gantry dryers are available for total respray.

According to the invention, the IR radiator is positioned so that the radiator distance ranges from 20 to 60 cm, preferably from 20 to 50 cm, whereby the values defined above for the parameter Q must also be observed. For example, when using a IR radiator having a radiator power of 3 kW a radiator distance of 30 to 35 cm can be used, and when using a IR radiator having a radiator power of 6 kW a radiator distance of 45 to 50 cm can be used. During irradiation, object temperatures for example of from 100 to 140° C., in particular from 100 to 130° C. can be attained and should be ensured. Higher object temperatures could lead to the coating becoming damaged and therefore temperature control is necessary. The object temperature is understood as meaning the temperature of the coated substrate prevailing on the surface thereof and thus, with respect to the heat radiation thereof, is the temperature which may be measured from the outside. The object temperature may be measured without contact in a known manner using conventional temperature measuring devices, for example testo 825-T1 or testo 825-T2 from testo AG. Usually the IR radiators itself are equipped with a temperature control device (pyrometer control) adjusting the actual temperature to the target temperature. In that case external temperature control is not necessary.

IR radiators may be equipped in addition with a temperature management control for the heating phase (so-called ramp), which ensures a controlled heating of the surface to be radiated. For example an increase of temperature of 20-40° C. per minute can be adjusted to reach the final target temperature. Ramp times of for example 0.5 to 4.0 minutes are possible in principle. Even if not preferred such temperature control can be used in the present invention. But it would unnecessarily extend the curing time, if the ramp time is not very short.

As mentioned above, radiation takes place directly after application of the coating compositions. The actual radiation time is approximately 2 to 4 minutes, and the total process time is approximately 3 to 6 minutes. Radiation time is defined as the time between putting on the already positioned IR radiator in the proper radiation distance and the removal/turning off of the IR radiator, with other words the time the coated surface is actually exposed to IR radiation. The total process time contains, in addition to the actual radiation time, a set-up time (as mentioned above) of approximately 1 to 2 minutes or less, which is necessary, for example, to prepare the IR radiator and to position it accordingly. The set-up time shall be kept as short as possible. The curing/radiation times which are greatly reduced compared to conventional IR drying conditions are achieved by observing the aforementioned application conditions (radiator distance, no evaporation phase), without having to accept an inferior quality of the visual surface characteristics.

The radiation times mentioned here and above in the description refer to solvent-based clear coats and solvent-based single-layer topcoats. But remarkable reduced radiation times can also be achieved when using water-based clear coats and water-based single-layer topcoats. The quality of other technological characteristics, such as hardness, chemical resistance and gloss and flow are also achieved to a satisfactory standard. The topcoatings which are obtained according to the invention exhibit an improved feel, i.e. a tangibly higher smoothness of the coating compared to the prior art method using IR technology. The topcoatings may be polished very effectively immediately after being irradiated. However, it is advantageous to wait for the coated substrate to cool down before it is polished.

The method according to the invention may advantageously be used in vehicle refinishing, that is both within the scope of classic vehicle refinishing, for example in a refinishing body shop, as well as for refinishing in the case of vehicles undergoing initial painting at the manufacturing plant. All in all, the method according to the invention provides the advantage of a considerable saving of time and, as a result thereof, also a saving in energy costs. The painting process may be designed to be more flexible and rational. In addition a faster curing time minimizes the risk of dust caught in the coating and also can reduce the need for polishing

The invention will now be described in more detail using the following examples.

### EXAMPLES

### Example 1

A commercially available silver-metallic water-based base coat composition (Brilliant Silver Metallic Base coat composition MB 744, Standox GmbH) was applied in a dry layer thickness of approximately 12 μm to a sample panel coated with a cathodic electro-deposition primer.

After an evaporation time of 20 minutes at room temperature, a commercially available two-component high-solid clear coating composition based on hydroxyl-functional binder and polyisocyanate hardener (Permasolid HS Optimum Clear coating composition 8600, Spiess Hecker+Permasolid VHS Hardener 3240, volume ratio 3:1) was applied to the base coat composition layer in a dry layer thickness of approximately 40 μm The application was carried out in two spray passes using a spray gun of the SATA RP3000 type, nozzle size 1.3 mm. Immediately after the application, within approximately 60 seconds, a short-wave IR radiator (IRT-401 XLNC from Hedson Technologies, single cassette head; radiator power: 6 kW) was positioned at a distance of 50 cm in front of the sample panel and the paint coating was irradiated for 3 minutes at full radiator capacity in order to cure it.

### Parameter Q=0.12

### Comparative Examples

### Comparative Example 1

In comparison, the procedure was carried out as described in Example 1 except that after the application of the 2K clear coating composition, an evaporation phase of 10 minutes at room temperature was interposed. The short-wave IR radiator, as used in Example 1, was then positioned at a distance of 80 cm in front of the sample panel and the paint coating was irradiated for 15 minutes at full radiator capacity for curing.

### Parameter Q=0.075

### Comparative Example 2

For comparison, the procedure was carried out as described in Comparative Example 1, except that the paint coating was irradiated for only 3 minutes (as in Example 1) at full radiator capacity for curing. The following table states the basic parameters of the curing procedure and various technological characteristics of the paint coating obtained in each case.

| Clear coating | | Comparative | Comparative |
|---|---|---|---|
| composition application | Example 1 | example 1 | example 2 |
| Final evaporation time | — | 10 min | 10 min |
| Set-up time | 1 min | 1 min | 1 min |
| Curing time | 3 min | 15 min | 3 min |
| Total process time | 4 min | 26 min | 14 min |
| Hardness (1) | very good | good | very poor |
| Gloss and Flow (2) | acceptable | acceptable | un-acceptable |
| | | | (microstructures |
| | | | visible; |
| | | | cloudiness) |
| Pinholes | none | none | clearly visible |
| | | | pinholes |
| Feel (3) | very smooth | smooth | not quite smooth |
| Assembly strength (4) | after 6 min | after 28 min | no assembly |
| | | | strength after 2 |
| | | | hours |

Curing time = radiation time

The results in the table show that the results produced by the method according to the invention are as good as those achieved in the conventional IR drying method with respect to hardness, surface quality (pinholes), gloss and flow, with a greatly reduced total process time. Moreover, an improvement in the feel (surface smoothness) could be achieved compared to Comparative Example 1. Comparative Example 2 shows that while observing the conventional conditions for IR irradiation (evaporation time, radiator distance) and by reducing the radiation time to the 3 minutes used in Example 1 according to the invention, it was not possible to achieve satisfactory technological characteristics, such as hardness, gloss and flow and surface quality.

As a result of the greatly reduced process time, a rapid assembly strength of the painted parts could also be achieved according to the invention, whereas in Comparative Example 2, basically no assembly strength was achieved due to incomplete curing at least in justifiable periods of time.

### Test Methods

(1) The hardness was assessed by a fingernail test one hour after the painted sample panel had cooled.
(2) Gloss and flow were assessed visually.
(3) The surface smoothness was assessed by touch with respect to feel.
(4) The details of time for the assembly strength include the period of time from the end of the application, including 2 minutes cooling time after the end of irradiation.

The invention claimed is:

1. A method for vehicle refinishing comprising:
A) applying a layer of a pigmented coating composition over an area of a pre-coated surface of a vehicle body or vehicle body part, subsequently applying a layer of clear coating composition over said layer of a pigmented coating composition, and
B) curing said layers applied in step A) by exposing said layers to infrared radiation directly after completion of said step A), without using an evaporation phase, wherein a short-wave infrared radiator is used, a radiator distance being adjusted in the range from 20 to 60 centimeters and wherein a quotient of radiator power in Kilowatt of said short-wave infrared radiator to the radiator distance in centimeters ranges from 0.07 to 0.15.

2. A method for vehicle refinishing comprising:
A) applying a layer of a pigmented top coating composition over an area of a pre-coated surface of a vehicle body or vehicle body part, and
B) curing said coating layer applied in step A) by exposing said layer to infrared radiation directly after completion of said step A), without using an evaporation phase, wherein a short-wave infrared radiator is used, a radiator distance being adjusted in the range from 20 to 60 centimeters and wherein a quotient of radiator power in Kilowatt of said short-wave infrared radiator to the radiator distance in centimeters ranges from 0.07 to 0.15.

3. The method according to claim 1 or claim 2, wherein the radiator distance ranges from 20 to 50 centimeters.

4. The method according to claim 1 or 2, wherein the quotient of radiator power and radiator distance ranges from 0.10 to 0.12.

5. The method according to claim 1 or 2, wherein the radiation time ranges from 2 to 4 minutes.

6. The method according to claim 5, wherein the radiation time ranges from 2 to 3 minutes.

7. The method according to claim 1, wherein said clear coating composition is water based.

8. The method according to claim 1, wherein said clear coating composition is solvent based.

9. The method according to claim 2, wherein said pigmented top coating composition is water based.

10. The method according to claim 2, wherein said pigmented top coating composition is solvent based.

11. The method according to claim 1 or 2, wherein said curing by exposing to infrared radiation is carried out within 10 to 120 seconds after completion of step A).

12. The method according to claim 11, wherein said curing by exposing to infrared radiation is carried out within 20 to 90 seconds after completion of step A).

13. The method according to claim 1, wherein the clear coating composition is two-component coating composition based on hydroxyl functional binders and polyisocyanate crosslinkers.

14. The method according to claim 2, wherein the pigmented top coating composition is two-component coating composition based on hydroxyl functional binders and polyisocyanate crosslinkers.
